(19) United States
(12) Patent Application Publication
(10) Pub. No.: US 2012/0299790 A1
(43) Pub. Date: Nov. 29, 2012

(54) FOLDED-DIPOLE FLAT-PLATE ANTENNA

(76) Inventor: Khamprasith Bounpraseuth, Maisons Alfort (FR)

(21) Appl. No.: 13/576,244

(22) PCT Filed: Feb. 4, 2011
(86) PCT No.: PCT/FR2011/000071

§ 371 Date: Jul. 31, 2012

(30) Foreign Application Priority Data
Feb. 5, 2010 (FR) 1000472

(51) Int. Cl. H01Q 9/26; H01Q 19/10; H01Q 9/28

(52) U.S. Cl. 343/795

(57) ABSTRACT

The antenna (1) includes:
a flat radiating plate (100) having three slots formed therein in a T-shaped configuration, with first and second ones of those slots (161, 162) forming the base of the T-shape and with a third one of those slots forming the leg of the T-shape, the third slot (163) being the only slot to open out into the peripheral edge (101) of the radiating plate, the three slots defining two wings (120, 130) situated on either side of the third slot; and
an electrical cable including a first electrical conductor connected to a first one of the wings and a second electrical conductor is connected to a second one of the wings.

### TECHNICAL FIELD TO WHICH THE INVENTION RELATES

The present invention relates in general manner to antennas that are suitable for transmitting and receiving ultra-high frequency (UHF) signals of the digital terrestrial television (DTT) type or of the analog type, in a frequency band lying more particularly in the range 471 megahertz (MHz) 783 MHz.

### TECHNOLOGICAL BACKGROUND

Antennas for receiving UHF signals are constituted mainly by rake antennas and by flat-plate or “slot” antennas.

In conventional manner, rake antennas comprise a plurality of rods mounted on a support arm, comprising a rear rod, referred to as the “reflector”, an intermediate rod referred to as the “radiating” rod, and a front rod referred to as the “director”. Those various rods are tuned as a function of the wavelengths of the signals to be received.

The radiating rod constitutes the active element of that antenna, since it is the radiating rod that delivers the UHF signals to the television set via a coaxial cable. It forms a loop around she support arm, with two strands connected respectively to the inner and outer electrical conductors of the coaxial cable. That radiating rod is of a shape somewhat reminiscent of a paperclip.

The major drawbacks of such a rake antenna are its considerable overall size and its unattractive appearance, which means that it can be installed only on the roof of a dwelling.

Flat-plate antennas mitigate those drawbacks. However, most of them generally present a narrow frequency bound for transmitting and receiving signals, which means that they cannot cover all DTT type UHF signal frequencies.

Nevertheless, a flat-plate antenna is disclosed in document FR 2 841 688 that comprises a rectangular radiating plate including two main slots that are parallel and connected to each other by a narrow slot. By means of those slots, that antenna presents a broad band for transmitting and receiving signals. In particular, that antenna is suitable for receiving all of the DTT type UHF signal frequencies.

The major drawback of that antenna is that its slots, which are cut out in the radiating plate at a distance from its peripheral edge and which are dimensioned to be tuned to the DTT type UHF signal frequencies, require the use of a radiating plate that is of large dimensions, to the detriment of the overall size of the antenna.

Document WO 2005/041355 discloses an antenna of the “folded dipole” type that comprises firstly a flat plate in which three slots are formed in a T-shaped configuration, thereby defining two wings, and secondly a cable having one conductor connected to one of the two wings and having another conductor connected to the other one of the two wings. The electrical conductors are connected in that antenna to tongues that extend the wings.

The drawback of such an antenna is that it presents impedance that does not enable DTT type signals to be well received, unless resistances are provided in the electrical conductors.

### OBJECT OF THE INVENTION

In order to remedy the above-mentioned drawbacks of the prior art, the present invention proposes an antenna having dimensions that are about 40% smaller than those of the antenna disclosed in document FR 2 841 688, while presenting substantially identical gain over the entire frequency band of DTT type UHF signals, and that presents optimum impedance.

More particularly, the invention provides an antenna comprising:
a flat radiating plate having three slots formed therein in a T-shaped configuration, with first and second ones of those slots forming the base of the T-shape and with a third one of those slots forming the leg of the T-shape, said third slot being the only slot to open out into the peripheral edge of the radiating plate, said three slots defining two wings situated on either side of the third slot; and
an electrically conductive element, such as a coaxial cable, comprising a first electrical conductor connected to the end edge of a first one of said wings and a second electrical conductor connected to a second one of said wings via at least two distinct contact spots or via a continuous line of contact.

Thus, the radiating plate forms a dipole folded like a clip, with its two ends defining the third slot. Because of this folded clip shape, the radiating plate of the antenna is of small overall size. It is also adapted to radiate over a frequency band that is broad enough to pick up all DTT type UHF signals. The connection between the electrical conductor element and the wings enables the antenna to be well matched in impedance, so that it presents considerable gain enabling it to pick up signals of low power.

The antenna in accordance with the present invention may present other characteristics that are advantageous and not limiting, as follows:
said second wing presents a height and a width defined in the plane of the radiating plate, the second electrical conductor is connected at a distance from said edge of the second wing that lies in the range one-fifth to one-half of the width of the second wing;
the radiating plate presents, when folded out flat, a width equal to 200 millimeters (mm), to within 20%;
the radiating plate presents, when folded out flat, a height equal to 100 mm, to within 20%;
said electrical conductor element is a coaxial cable presenting an impedance of 75 ohms (Q);
each wing extends along an axis of symmetry;
said first and second electrical conductors are connected respectively to the first and second wings at a distance from said axis of symmetry;
opposite from said first and second slots, each wing presents an edge that is provided with a flap;
each flap is situated in the plane of the radiating plate;
each flap is folded in a plane that is inclined relative to the plane of the radiating plate;
said first and second slots extend lengthwise to a distance from the peripheral edge of the radiating plate that lies in the range 5 mm to 65 mm;
a reflector is provided comprising a flat plate positioned parallel to the plane of the radiating plate, the height and the width of the reflector being greater than or equal to the height and the width of the radiating plate;
the flat plate of the reflector lies between two flanges extending towards the radiating plate over a distance that is less than or equal to half the distance between the radiating plate and the flat plate of the reflector; and
the radiating plate extends over one of the faces of a printed circuit substrate, and at least one of the electrical conductors is formed by a printed circuit track extending over the other face of said substrate.

### DETAILED DESCRIPTION OF AN EMBODIMENT

The following description given by way of non-limiting example and with reference to the accompanying drawings makes it possible to understand what the invention consists in and how it can be reduced to practice.

In the accompanying drawings

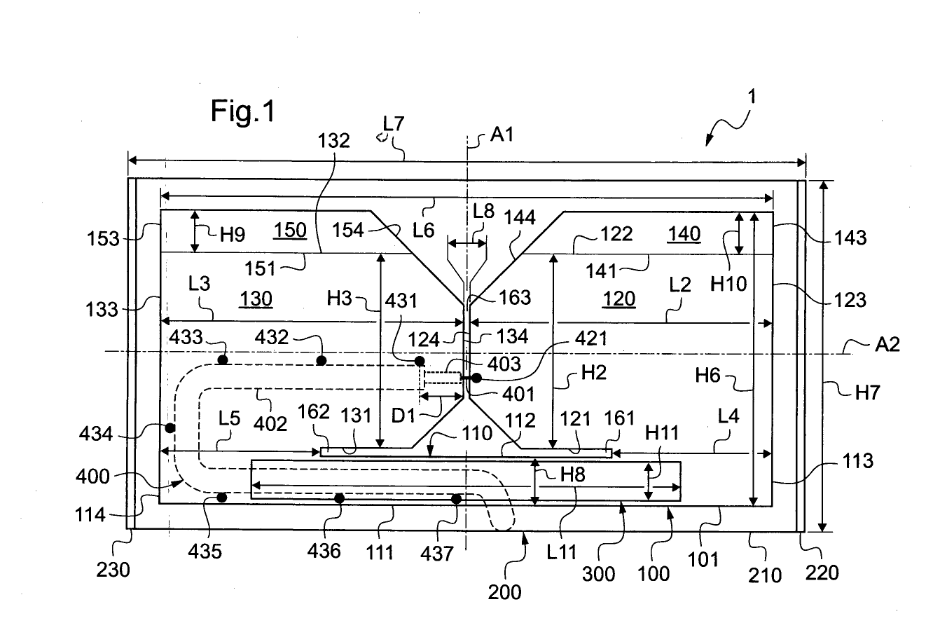

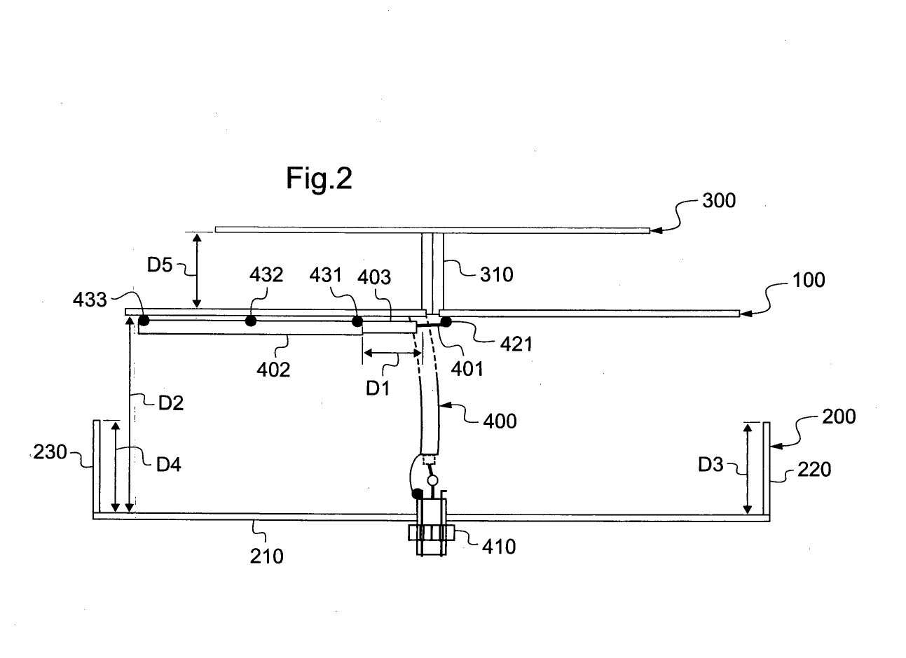

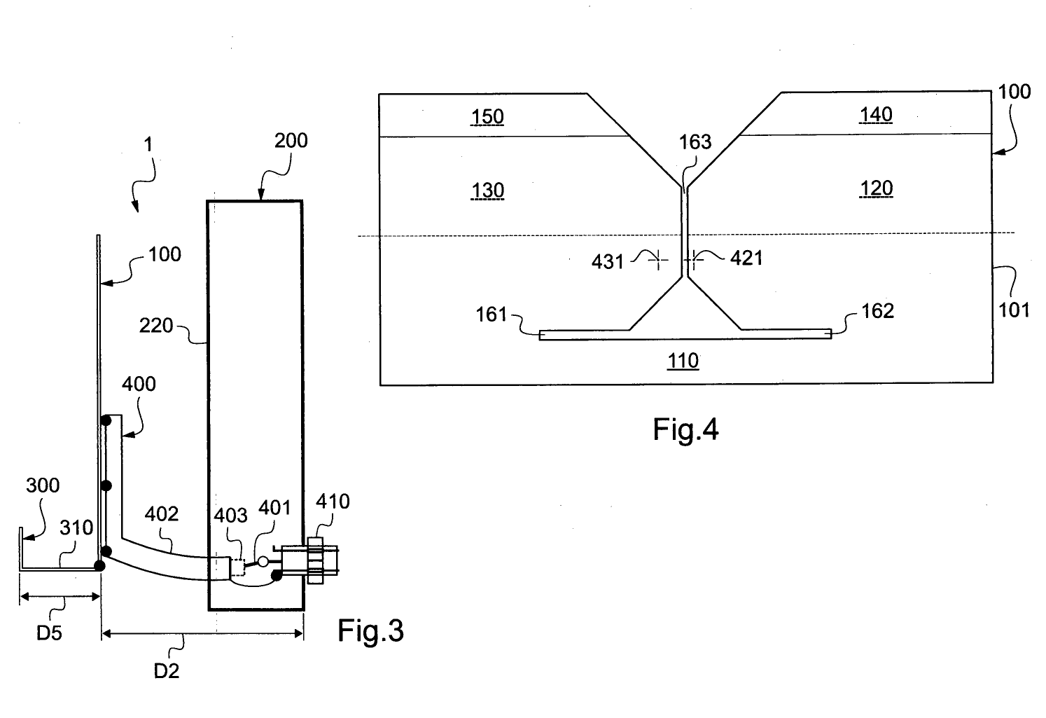

FIGS. 1 to 3 are diagrams of a flat-plate antenna of the invention respectively in face view, in plan view, and in side view;

FIG. 4 is a diagrammatic face view of a variant embodiment of the radiating plate shown in FIGS. 1 to 3; and

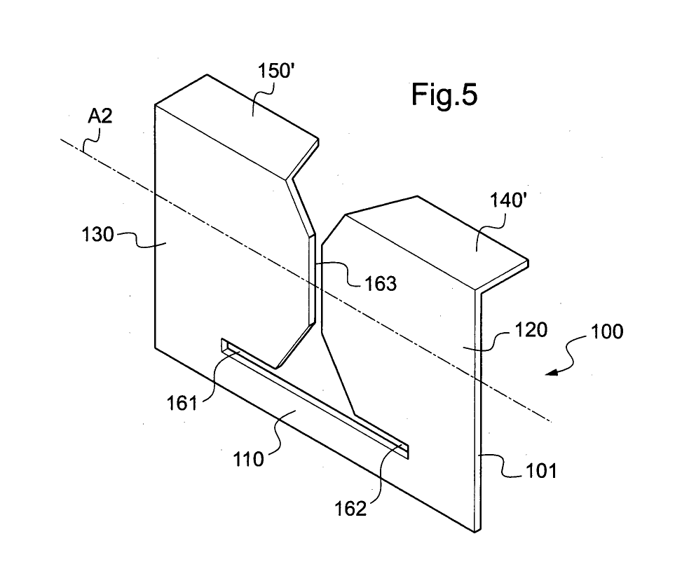

FIG. 5 is a diagrammatic perspective view of a variant embodiment of the radiating plate of the flat-plate antenna of FIG. 1

As shown in FIGS. 1 to 3, the flat-plate antenna 1 is designed to pick up UHF signals. It is also designed to present high gain so as to be capable of picking up signals of low power. The flat-plate antenna 1 is particularly suitable for receiving digital radiofrequency (RF) signals of the DTT type that often present lower power than analog RF signals.

This flat-plate antenna 1 is directional. It is therefore designed to be placed in an optimum position for receiving signals, facing in the main propagation direction of the signals. In this position, the height and the width of the flat-plate antenna are defined respectively as the vertical and horizontal directions of the flat-plate antenna 1 that are perpendicular to the main direction of signal propagation.

The flat-plate antenna 1 has two essential elements, namely a radiating plate 100 and an electric cable 400 connected to the radiating plate 100.

The radiating plate 100 constitutes the active element of the flat-plate antenna 1, since it is this plate that delivers the signals to the television set via the electric cable 400.

According to a particularly advantageous characteristic of the flat-plate antenna 1, and as shown more particularly in FIG. 4, the radiating plate 100 is substantially rectangular and flat. It is cut so as to define three slots 161, 162, and 163 in a T-shaped configuration, with only the slot 163 opening out to the rectangular peripheral edge 101 of the radiating plate 100.

The two slots 161 and 162 that form the base of the T-shape then co-operate with the bottom side of the peripheral edge 101 of the radiating plate 100 to form a portion 110 referred to as the support portion.

The third slot 163, which forms the leg of the T-shape, co-operates with the top side of the peripheral edge 101 of the radiating plate 100 and with the two slots 161 and 162 to define two wings 120, 130.

The electrical conductors 401 and 402 of the electric cable 400 are connected respectively to these two wings 120, 130.

Advantageously, and as shown in FIGS. 1 to 3, the flat-plate antenna 1 also includes, beside opposite faces of the radiating plate 100, a reflector 200 and a director 300. These two elements 200 and 300 are tuned in frequency with the radiating plate 100 in order to optimize the performance of the radiating plate 100.

In a variant, and in order to reduce its overall size, provision may be made for the flat-plate antenna 1 to omit one and/or the other of these two elements 200, 300, but it would then nevertheless, present reduced performance.

### Radiating Plate

As shown in FIG. 1, the radiating plate 100 forms a flat-plate folded dipole antenna that may be thought of as the paperclip-shaped rod of a rake antenna. In this example, the radiating plate 100 presents a vertical axis of symmetry A1.

Because of its folded and flat shape, the radiating plate 100 presents size that is small, being about 40% that of a standard flat-plate antenna, and it therefore presents less wind resistance.

The total width L6 of the radiating plate 100 is selected as a function of the low frequency of the flat-plate antenna 1. In this example, the radiating plate 100 presents a total width L6 equal, to within 20%, to 200 mm.

The total height H6 of the radiating plate 100 is selected as a function of the high frequency of the flat-plate antenna 1. It is not selected to be any greater so as to avoid reducing the gain of the flat-plate antenna 1 in this example, the radiating plate 100 presents a total height H6 equal, to within 20%, to 100 mm.

The thickness of the radiating plate 100 in this example is particularly small, being of the order of 0.3 mm, so as to reduce the cost of the raw materials needed for fabricating the flat-plate antenna 1.

As shown more particularly in FIG. 1, the support portion 110 of the radiating plate 100 is in the shape of a rectangle that is elongate in the width direction of the antenna. It thus has a bottom edge 111 and a top edge 112 that are mutually parallel, and also two end edges 113 and 114 that are likewise mutually parallel.

Each wing 120, 130 presents the shape of a flat rectangular plate that is elongate in the width direction of the antenna, and that has a horizontal axis of symmetry A2. Each wing 120, 130 thus has a bottom edge 121, 131 and a top edge 122, 132, which edges are mutually parallel, and also an outside edge 123, 133 and a free end edge 124, 131, which are likewise mutually parallel. As shown in FIG. 1, the free end edges 124, 134 of the two wings face each other so as to define between them the third slot 163.

Each wing 120, 130 presents a height H2, H3 that is at least twice the height H8 of the support portion 110. In this example and preferably, the two corners of the free end edge 124, 134 of each wing 120, 130 are chamfered at 45 degrees. Thus, the third slot 163 presents a desired length tuned to the frequency band of digital RF signals of the DTT type.

Each wing 120, 130 in this example presents a height. H2, H3 equal to 70 mm, to within 20%.

The wings 120, 130 also present widths L2, L3 such that the third slot 163 situated between their free end edges 124, 134 presents a width. L8 that is small, less than 5 mm. Because of this small width, the third slot 163 enables the flat-plate antenna 1 to radiate over the entire frequency band of DTT type digital RF signals.

Each wing 120, 130 in this example presents a width L2, L3 that is equal to 98 mm, to within 20%.

The wings 120, 130 and the support portion 110 extend edge to edge. The bottom edge 121, 131 of each wing 120, 130 is attached to the top edge 112 of the support portion 110 over a fraction only of its length. The bottom edge 121, 131 of each wing 120, 130 is otherwise spaced apart from the top edge 112 of the support portion 110 in order to define the first or second slot 161, 162.

The first and second slots 161, 162 extend lengthwise from the third slot 163 towards the outside edges 123, 133 of the wings 120, 130, to a distance L4, L5 from said edges lying in the range 5 mm to 65 mm, and preferably equal to 50 mm, to within 20%. The first and second slots 162, 163 are thus of short length, to the benefit of the gain of the flat-plate antenna 1.

Preferably, each wing 120, 130 is extended by its top edge 122, 132 by a flap 140, 150 that enables the breadth of the frequency band in which the flat-plate antenna 1 radiates to be enlarged. Each flap 140, 150 in this example is of trapezoidal shape, having a bottom edge 141, 151 that is attached to the top edge 122, 132 of the corresponding wing 120, 130, an outer edge 143, 153 that extends the outer edge 123, 133 of the corresponding wing 120, 130, and an inner edge 144, 154 that extends the chamfer of the free end edge 124, 134 of the corresponding wing 120, 130. Each flap 140, 150 in this example presents a height H9, H10 lying in the range 5 mm to 20 mm.

In this example, the radiating plate 100 is formed by being cut out from a metal sheet. The metal material is selected not only to be highly conductive, but also to be inexpensive. In this example, the radiating plate 100 is made of a single piece of copper. In a variant, it could be cut out from some other material, such as for example aluminum or brass.

Also in a variant, it is possible to make provision for the antenna to be fabricated from an integrated circuit having a rigid substrate that is covered on one face in a metal sheet forming said radiating plate. Such an antenna is nevertheless more difficult to recycle than the antenna described above.

### Coaxial Cable

The electric cable 400 is designed to convey the signals picked up by the radiating plate 100 to the demodulator of the television set.

For this purpose, it presents one end fitted with a connector 410 for connection to the television set, and an opposite end connected to the radiating plate 100.

The electric cable 400 is preferably a coaxial cable having a central core 401 surrounded by insulating dielectric material 403, itself surrounded by a braided conductive sheath, referred to as “shielding” 402 that is in turn covered by an insulating covering (not shown).

The coaxial cable 400 in this example presents a standard impedance of 75Ω, that is optimized for conveying video signals. It is also selected so as to present small losses.

Preferably, the central core 401 of the coaxial cable 400 is connected to the free end edge 124 of the wing 120, while the shielding 402 is connected to the wing 130 at a distance from its free end edge 134 so as to avoid being in direct electrical contact with this free end edge.

For this purpose, the end of the shielding 402 is cut away at a distance from the end of the central core 401 so that only the insulating dielectric material 403 comes into contact with the free end edge 134 of the wing 130.

This asymmetry of the connection of the coaxial cable 400 to the two wings 120, 130 makes it possible to optimize the impedance matching of the flat-plate antenna 1 so that it picks up as well as possible DTT type digital Ra signals.

The shielding 402 in this example is connected more specifically at a distance D1 from the free end edge 134 of the wing 130, which distance lies between one-fifth and one-half of the width L3 of the wing 130.

In this example, and as shown in FIG. 1, the central core 401 is connected to the free end edge 124 of the wing 120 via a single spot of solder. The shielding 402 is connected to the wing 130 at four points by spots of solder 431-434 that are distinct and spaced apart at regular intervals along the cable. It is also connected to the support portion 110 by three other spots of solder 435-437. This plurality of spots of solder situated at a distance from the free end edge 134 of the wing 130 serves to reduce the impedance of the antenna to 75Ω without the assistance of electronic components (resistors, . . . ) even though the impedance would be about 300Ω if the shielding 402 were connected via a single point contact to the free end edge 134 of the wing 130. This thus serves to improve the impedance matching of the flat-plate antenna 1.

In a variant, it would naturally be possible to make provision for the shielding 402 to be connected to the wing 130 by some other number of solder spots, or by a continuous bead of soldering.

In this example, the solder spots connecting the central core 401 and the shielding 402 to the wings 120, 130 are situated at a distance from the horizontal axis of symmetry A2 of the wings 120, 130. In this flat-plate antenna 1, there is no need to connect the coaxial cable 400 along the horizontal axis of symmetry A2 of each wing 120, 130, thereby facilitating the operations of fabricating the flat-plate antenna 1. As shown in the figures, these spots of solder are situated beneath the horizontal axis of symmetry A2 of the wings 120, 130 in a variant, they could be situated above said axis.

### Reflector

As explained above, in this example the flat-plate antenna 1 includes, in addition to the two essential elements that are the radiating plate 100 and the coaxial cable 400, a reflector 200.

The reflector 200 serves firstly to concentrate the digital RF signals on the radiating plate 100, and secondly to reduce echo phenomena By means of the reflector 200, the directivity of the flat-plate antenna 1 is significantly increased, so that it presents gain that is about 3 decibels (dB) greater than that of a flat-plate antenna without such a reflector.

In this example, and as can be seen in FIGS. 1 to 3, the reflector 200 has a rectangular flat plate 210 that is positioned parallel to and at a distance from the radiating plate 100. This flat plate 210 is thus positioned behind the radiating plate 100 so as to form a ground plane that improves the front-to-back ratio of the flat-plate antenna 1.

The flat plate 210 of the reflector 200 is preferably positioned at a distance D2 from the radiating plate 100 that lies in the range 50 mm to 100 mm, and that is equal to 70 mm in this example.

The flat plate 210 of the reflector presents a height H7 and a width L7 that are greater than or equal to the total height H6 and the total width L6 of the radiating plate 100.

The dimensions of the flat plate 210 are derived more specifically as a compromise between the overall size of the flat-plate antenna 1 and the performance contributed by the reflector 200.

In this example, the width L7 and the height H7 of the flat plate 210 are selected to be 10 mm greater than the total height H6 and the total width L6 of the radiating plate 100, such that the face view of FIG. 1 shows the flat plate 210 of the reflector 200 projecting by half a centimeter beyond either side of the radiating plate 100.

Advantageously, the flat plate 210 of the reflector 200 has two rectangular flanges 220, 230 that extend perpendicularly from the two opposite short sides of the flat plate 210 towards the radiating plate 100.

These two flanges 220, 230 thus extend orthogonally to the polarization plane of the radiating plate 100. They serve to optimize the performance of the reflector but without that increasing the overall size of the antenna.

As shown in the figures, these two flanges 220, 230 extend lengthwise over the full height H7 of the flat plate 210 of the reflector 200. They also extend towards the radiating plate 100 over a distance D3, D4 that is less than or equal to half the distance D2 between the radiating plate 100 and the flat plate 210 of the reflector 200, so as to avoid degrading the impedance of the flat-plate antenna 1. In this example, the distance D3, D4 is equal to 30 mm.

Advantageously, the reflector 200 is obtained by an operation of cutting out and folding a metal sheet made of copper or of aluminum, so that its manufacturing cost is small.

### Director

As explained above, the flat-plate antenna 1 includes at least one director 300 positioned parallel to the radiating plate 100, and in front of it.

Such a director 300 serves to increase the gain of the flat-plate antenna 1 at the higher frequencies at which it radiates.

As shown in the figures, in this example the flat-plate antenna 1 includes a single director 300 positioned at a distance D5 from the radiating plate 100.

This distance D5 is greater than 20 mm so that the antenna remains in the transmission and reception frequency band covered by DTT type signals.

It is also less than 40 mm so that the overall size of the antenna remains, small and so as to reduce energy dissipation.

Naturally, provision could be made in a variant for the flat-plate antenna 1 to have a greater number of directors, e.g. two or three in parallel superposition and spaced apart from one another.

In this example, the director 300 is in the form of a rectangular plate of height and width that are smaller than the height and width of the support portion 110 of the radiating plate 100. More particularly, it presents a height H11 lying in the range 2 mm to 10 mm, 8 mm in this example, and a width L11 lying in the range 100 mm to 200 mm, 150 mm in this example.

Like the radiating plate 100 and the reflector 200, the director 300 is obtained by being cut from a metal sheet of copper or aluminum, such that the total cost of fabricating the flat-plate antenna 1 is small.

In a variant, provision could also be made for the director to present some other shape, e.g. a tubular shape of diameter lying in the range 2 mm to 10 mm.

### Box

In order to enable the flat-plate antenna 1 to radiate as well as possible, the radiating plate 100 and the reflector 200 are held relative to each other in a fixed and parallel position.

For this purpose, they are rigidly fastened to the inside of a protective box (not shown) made of a non-conductive material.

The box thus serves not only to protect the radiating plate 100 and the reflector 200, but also to ensure that these two elements are accurately parallel to each other.

In this example, the box is made of a composite material based on wood so as to be less polluting than a box made of plastics material, and consequently so as to be easier to recycle.

The director is arranged to emerge from the front of the box. For this purpose, it is held parallel to the radiating plate 100 by a rigid leg 310 that may be conductive or non-conductive and that extends from the front face of the support portion 110 of the radiating plate 100 to the rear face of the director 300 through an opening provided in the box.

The present invention is not limited in any way to the embodiments described and shown, and the person skilled in the art knows how to apply any variant thereto in accordance with its spirit.

In particular, provision may be made for the box to act only as a protective member for the flat-plate antenna 1, in which case the radiating plate 100 and the reflector 200 should be held spaced apart and parallel to each other by rod-shaped spacers.

In another embodiment of the invention (not shown in the figures), in order to further reduce the overall size of the antenna, it is possible to replace the coaxial cable of circular section with an electrical conductor element of flat section.

In this embodiment, the antenna includes a printed circuit made up of an insulating substrate (e.g. made of Bakelite) and at least one conductor track (e.g. made of copper) extending on one of the faces of the substrate.

The radiating plate is then formed by a thin metal layer of shape identical to the radiating plate shown in FIG. 1, and extending on the other face of the printed circuit substrate.

In other words, the insulating substrate carries the radiating plate on one of its two faces, and the conductive track on its other face.

In this variant, the electrically conductive element is formed in part by the conductive track. This electrically conductive element comprises more precisely firstly an electric wire connected to the support portion of the radiating plate at a point situated on the vertical axis of symmetry A1 of the antenna, and secondly said conductive track.

The track then extends over the substrate along a path that is substantially identical to that of the coaxial cable shown in FIG. 1, with a first portion extending along the support portion of the radiating plate, on the opposite side of the substrate, and a second portion extending along one of the wings of the radiating plate, on the opposite side of the substrate, along the horizontal axis of symmetry A2 of the wing.

In this example, the track presents a width that is substantially equal to 3 mm, to within 20%. It thus presents optimum impedance matching.

The end of the track extends at a distance D1 from the third slot of the radiating plate, which distance lies between one-fifth and one-half of the width of the corresponding wing of the radiating plate.

This end is extended by an electric wire of small diameter, equal to about 0.3 mm, that extends to beyond the third slot and that is connected to the other wing of the radiating plate via a hole drilled through the substrate of the printed circuit.

In this example, the thickness of the material of the substrate is selected so that the electrical conductor presents a characteristic impedance of 75 Ω.

This particularly flat antenna is preferably not provided with a reflector or a director so as to present thickness that is particularly small. This antenna may also include a protective covering molded on the printed circuit so as to be easily transportable.

FIG. 5 shows another variant embodiment, of the radiating plate 100.

This radiating plate 100 is of a shape that is close to that of the radiating plate shown in FIG. 1. It is obtained from a flat plate of width that is equal to 200 mm (to within 20%) and of height that is equal to 1.00 mm (to within 20%). It is cut to have the three slots 161, 162, and 163 in a T-shaped configuration, so as to define a support portion 110, and two winos 120, 130 each presenting an axis of symmetry A2.

In this variant, the wings of the radiating plate 100 are extended on their edges opposite from the support portion 110 by flaps 140′, 150′ that are folded at right angles relative to the plane of the wings 120, 130.

In this variant, the directivity of the antenna is a little less than that of the antenna shown in FIG. 1 (the gain of this antenna is about 0.3 dB less than the gain of that antenna), but its overall size is much smaller.

In order to further reduce the overall size of the antenna, it is also possible to make provision for its support portion 110 to be folded parallel to the flaps 140′, 150′.

1. An antenna (1) comprising:
a flat or folded radiating plate (100) having three slots (161, 162, 163) formed therein in a T-shaped configuration, with first and second ones of those slots (161, 162) forming the base of the T-shape and with a third one of those slots (163) forming the leg of the T-shape, said third slot (163) being the only slot to open out into the peripheral edge (101) of the radiating plate (100), said three slots (161, 162, 163) defining two wings (120, 130) that are situated on either side of the third slot (163) and that presents two facing end edges (124, 134) defining said third slot (163); and
an electrically conductive element (400) comprising a first electrical conductor (401) connected to the end edge (124) of a first one of said wings (120) and a second electrical conductor (402) that is connected at a distance from the end edge (134) of a second one of said wings (130) via at least two distinct contact spots (431-437) or via a continuous line of contact.

2. An antenna (1) according to claim 1, including at least one director (300) positioned parallel to the plane of the radiating plate (100).

3. An antenna (1) according to claim 1, wherein, said second wing (130) presents a height (H3) and a width (L3) defined in the plane of the radiating plate (100), the second electrical conductor (402) is connected at a distance (D1) from said end edge (134) of the second wing (130) that lies in the range one-fifth to one-half of the width (L3) of the second wing (130).

4. An antenna (1) according to claim 1, wherein the radiating plate (100) presents, when folded out flat, a width equal to 200 mm, to within 20%.

5. An antenna (1) according to claim 1, wherein the radiating plate (100) presents, when folded out flat, a height (H6) equal to 100 mm, to within 20%.

6. An antenna (1) according to claim 1, wherein said electrical conductor element (400) is a coaxial cable presenting an impedance of 75Ω.

7. An antenna (1) according to claim 1, wherein each wing (120, 130) extends along an axis of symmetry (A2).

8. An antenna (1) according to claim 7, wherein said first and second electrical conductors (401, 402) are connected respectively to the first and second wings (120, 130) at a distance from said axis of symmetry (A2).

9. An antenna (1) according to claim 7, wherein, opposite from said first and second slots (161, 162), each wing (120, 130) presents an edge (122, 132) that is provided with a flap (140, 150; 140′, 150′).

10. An antenna (1) according to claim 9, wherein each flap (140, 150) is situated in the plane of the radiating plate (100).

11. An antenna (1) according to claim 9, wherein each flap (140′, 150′) is folded in a plane that is inclined relative to the plane of the radiating plate (100).

12. An antenna (1) according to claim 1, wherein said first and second slots (162, 163) extend lengthwise to a distance (L4, L5) from the peripheral edge (101) of the radiating plate (100) that lies in the range 5 mm to 65 mm.

13. An antenna (1) according to claim 1, including a reflector (200) comprising a flat plate (210) positioned parallel to the plane of the radiating plate (100), the height and the width (H7, L7) of the reflector being greater than or equal to the height and the width (H6, L6) of the radiating plate (100).

14. An antenna (1) according to claim 13, wherein the flat plate (210) of the reflector (200) lies between two flanges (220, 230) extending towards the radiating plate (100) over a distance (D3, D4) that is less than or equal to half the distance (D2) between the radiating plate (100) and the flat plate (210) of the reflector (200).

15. An antenna (1) according to claim 1, wherein the radiating plate extends over one of the faces of a printed circuit substrate, and wherein at least one of the electrical conductors is formed by a printed circuit track extending over the other face of said substrate.
